(19) United States
(12) Patent Application Publication
(10) Pub. No.: US 2004/0064611 A1
(43) Pub. Date: Apr. 1, 2004

(54) Disassembly of device stack that avoids physical disconnection/reconnection of device before stack rebuild

(76) Inventor: David Peyton Cox, Santa Barbara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/260,276

(22) Filed: Oct. 1, 2002

(51) Int. Cl. G06F 13/00

(52) U.S. Cl. 710/100

(57) ABSTRACT

A code arrangement, for use on a host connected via a bus to one or more, e.g., devices, causes stacks representing one of the devices to be disassembled such that rebuilding the stacks does not require physical disconnection and reconnection of the device(s). Such a stack includes a lower device object (DO) associated with the bus driver and an upper DO in the stack located above the lower DO. The upper DO is recognized as the physical DO (PDO) by a data structure associated with the device in a device tree. Such a code arrangement accomplishes: removal of each DO from the stack located above the lower DO including the PDO, the lower DO associated with the bus driver surviving as a remnant DO; and change of a state of the data structure in the device tree to permit rebuilding of the stack based upon the remnant DO.

### BACKGROUND OF THE INVENTION

The WINDOWS driver model (WDM) is a driver technology developed by the MICROSOFT Corporation that supports drivers which are compatible for WINDOWS 98, 2000, ME AND XP. WDM allots some of the work of the device driver to portions of the code that arc integrated into the operating system. These portions of code handle all of the low-level buffer management, including direct memory access (DMA) and plug-n-play (PnP) device enumeration.

A DRIVER_OBJECT data structure, corresponding to a single loaded device driver according to WDM, contains a table of function pointers referred to as the dispatch table. The numerical values used to index into the table, namely to find specific functions, are called function codes and are given symbolic names that refer to a type of input/output (I/O) such as READ or WRITE or refer to other requests such as CREATE, DEVICE_CONTROL and PnP.

The function located in the table at the corresponding index is expected to implement logic for carrying out such an I/O request. The operating system delivers I/O request packets (IRPs) to these functions. The operating system also, for each IRP, identifies the device for which the request is intended, in the form of a DEVICE_OBJECT data structure. Such a DEVICE_OBJECT was previously initialized by the driver and represents a single device handled (driven) by the driver. A driver defines its own dispatch functions and inserts them into the dispatch table in its DRIVER_OBJECT at the time the driver initializes itself. A device node (devnode) is the context (set of data structures and configuration storage) representing a single device within a WDM operating system. If the device is active (connected and enabled for use), then (in the kernel) such a context will include a stack of device object structures, typically one per driver in the layered driver architecture for that type of device.

Device objects (DOs) in the stack fall into three categories. The bottom-most device object is created by the driver for the bus that provides access to the device and is called the physical device object (PDO). The bus driver provides raw communications capability to the device, but little in the way of higher-level device-specific functionality. Typically a function device object (FDO) is created by a driver which provides access to device-specific and higher-level capabilities of the device. An FDO will be located higher in the device stack than a PDO. In addition to the PDO and FDO, there may optionally be one or more filter device objects (FiDOs). FiDOs may be located in the device stack between the PDO and FDO, or above the FDO.

FIG. 1 is a software block diagram that illustrates the layered relationships of objects according to the WDM architecture. Such a WDM architecture 100 includes devices 102, 103 and a bus 104 to which the devices 102, 103 are physically connected. A host computing device 105 is also connected to the bus 104. The host 105 has a variety of software loaded on it including an application 106, an application 136, a PnP manager 108, a bus DO enumerator 110, a bus function driver 112, an optional device lower filter driver 114, a device function driver 116 and an optional device upper filter driver 118.

In a storage area network (SAN), a device (not depicted) can be sub-divided into smaller units representing different functions, known as logical units (LUNs). Device 102 may be such a LUN. A device or LUN can represent a type of massive non-volatile storage, configuration functionality, monitoring functionality and/or mechanical functionality (such as tape changing), etc. The host 105 can have an application 106 that stores data to, reads data from and/or otherwise utilizes the functionality of device 102, i.e., consumes the services of the device 102. In some SANs, there can be multiple non-volatile memory devices or other devices 102, some of which the host 105 might not have permission to access.

When a device 102 is connected to a bus 104, the bus driver 112 notifies the operating system of a change on the bus by calling the kernel function IoInvalidateDeviceRelations( ). The operating system, i.e., the PnP manager 108, issues a request to the bus driver 112 via an IRP sent downward in the layered architecture instructing the bus driver 112 to return objects for all of the devices currently connected to the bus 104. In response to this query, the bus driver 112 creates PDOs for any devices newly connected to the bus, and then returns a set of pointers to (addresses of) all PDOs representing devices connected to the bus, including those previously albeit currently connected. Strictly speaking, the set of DOs whose addresses are returned are not PDOs until the operating system, namely the PnP manager, examines such a set and first becomes aware of the devices within the set.

The PnP manager 108 locates and loads into volatile memory (not depicted in FIG. 1) (if not already loaded) of the host 105 the function drivers and filter drivers for the newly-connected devices and gives each filter driver and/or function driver an opportunity to create and attach corresponding FiDOs or FDOs to the stack/node 128 rooted in the new PDO.

In FIG. 1, a stack 134 for the bus 104 is depicted. The stack 134 includes a PDO for the bus 130 (generated by the bus DO enumerator 110) and a bus FDO 132 (generated by the bus function driver 112).

A stack 128 for the device 102 has also been created. The stack 128 includes a PDO 120 (generated by the bus function driver 112), and (possibly) a FiDO 122 (generated by the optional device lower filter driver 114, if present), an FDO 124 (generated by the device function driver 116) and (possibly) an FiDO 126 (generated by the device upper filter driver 118, if present). In other words, if the device lower filter driver 114 and/or the device upper filter driver 118 are not present, then the FiDO 122 and/or the FiDO 126 will not be present, respectively.

Similarly, device 103 can have a stack 138 rooted in PDO 146. The stack 138 can include: optional FiDO 144 present only with, and corresponding to, lower filter driver 114; FDO 142 corresponding to function driver 116; and optional FiDO 140 present only with, and corresponding to upper filter driver 118.

In a situation in which the host 105 has multiple host bus adapters (not depicted in FIG. 1) and device 102 has multiple ports (not depicted in FIG. 1), then multiple paths can exist between the host 105 and the device 102. Within the host, each path is given its own path identification (ID). Each path is perceived as a distinct device and so has a corresponding stack 128, which includes the distinct path ID. Each stack is part of a data structure in a device tree referred to as a device node (devnode). As such, a host can have multiple devnodes, namely multiple stacks, for the same device.

Subsequently, when a device, e.g., 102, is to be disconnected or disabled, the one or several stacks must be disassembled. From the top down, under the coordination of the PnP manager 108, each driver detaches its device object from the stack and deletes it. At the bottom, however, the bus function driver 112 generally will not delete the corresponding PDO unless it has actually detected that the corresponding device is no longer connected to the bus.

### SUMMARY OF THE INVENTION

An embodiment of the invention provides a code arrangement (on a computer-readable medium for use in a system having a bus, a bus driver, a host connected to the bus and one or more devices connected to the bus), execution of which by one or more processors of the host causes a stack representing one of the devices to be disassembled such that rebuilding the stack does not require physical disconnection and reconnection of the device. Such a stack has a plurality of device objects (DOs), a lower DO in the stack being associated with the bus driver and an upper DO in the stack located above the lower DO being recognized as the physical DO (PDO) by a data structure representing the device in a device. Such a code arrangement includes: a removal code portion to remove each DO from the stack located above the lower DO including the PDO; the lower DO associated with the bus driver surviving as a remnant DO; and a state change code portion to change a state of the data structure in the device tree to permit rebuilding of the stack based upon the remnant DO.

Additional features and advantages of the invention will be more fully apparent from the following detailed description of example embodiments, the appended claims and the accompanying drawings.

### BRIEF DESCRIPTION OF THE DRAWINGS

FIG. 1 is a software block diagram according to the Background Art.

FIG. 2 is a hardware block diagram according to the an embodiment of the invention.

FIG. 3 is a hardware block diagram according to an embodiment of the invention.

FIG. 4 is a software block diagram according to an embodiment of the invention.

FIG. 5 is a sequence diagram according to the Background Art.

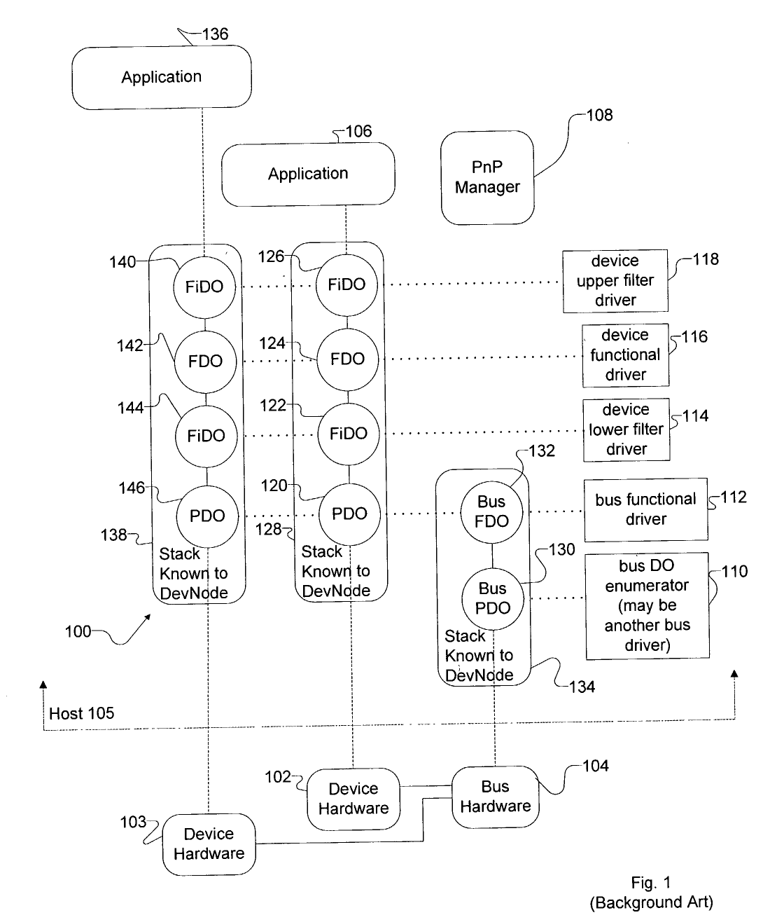

### DETAILED DESCRIPTION OF THE PREFERRED EMBODIMENTS

According to an embodiment of the invention, software is provided that facilitates disassembling a device stack and then being able to rebuild the stack without having to physically disconnect and reconnect the device, and alternatively also without having to reboot the host. Such software can be part of a greater system that coordinates access privileges of several hosts to network devices. Such system can be other software loaded on a host, e.g., that itself might not be able to access the devices.

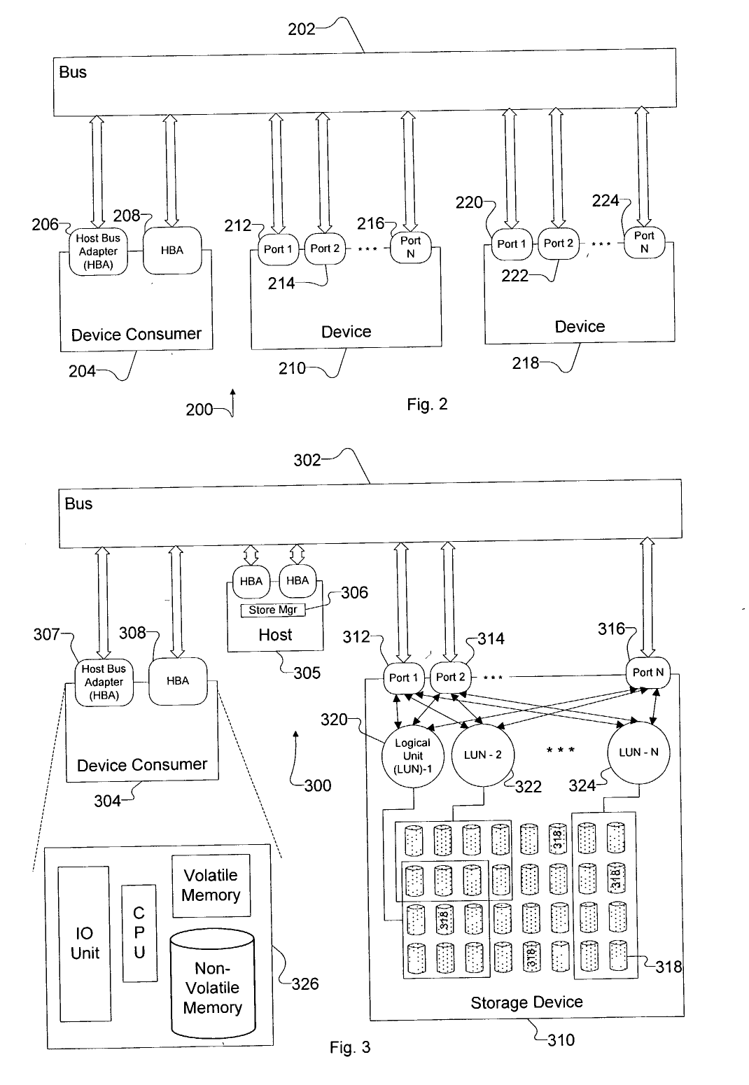

FIG. 2 depicts a hardware block diagram of a system 200 according to an embodiment of the invention. The system 200 includes a bus (e.g., SCSI, Ethernet (iSCSI/IP/Gbit Ethernet), fibre channel, etc.) 202 to which are connected a consumer of device services (hereafter a device consumer) 204, a device 210 and a device 218.

The device consumer 204 includes host bus adapters (HBAs) 206 and 208 that permit the device consumer 204 to connect to and interact with the bus 202. The device 210 has port 1 (212), port 2 (214), . . . port N (216). Device 218 has port 1 (220), port 2 (222), . . . port N (224). It is noted that the reuse of “N” as the variable for the number of ports is not meant to imply that different devices must have the same number of ports. For simplicity of disclosure, only two devices 210 and 218 and two HBA's 206 and 208 have been depicted, but fewer or more devices and fewer or more HBAs could be attached to the bus depending upon the particular circumstances of a situation.

FIG. 3 depicts a hardware block diagram corresponding to a particular type of system 200, namely a storage area system or storage area network (SAN) 300. The SAN 300 includes a bus 302, a host in the role of device consumer 304, another host 305 and a non-volatile storage device 310. The host 305 alternatively might be connected to bus 302, but could be connected to the host 304 by a different network (not depicted).

The device consumer 304 can include HBAs 307 and 308. Fewer or greater numbers of HBAs 307/308 can be provided depending upon the circumstances of a situation. So, in general, the device consumer (host) 304 can be considered to have a number of HBAs represented by the integer variable M.

The device consumer 304 can take the form of a computer 326 including at least a CPU, input device(s), output device(s) and memory. For example, the computer 326 has been depicted as including a CPU, a monitor, a keyboard, a mouse, volatile memory such as RAM and non-volatile memory such as ROM, flash memory, disc drives and/or tape drives. The host 305 can also be implemented via a computer 326.

The storage device 310 includes port 1 (312), port 2 (314), . . . port N (316) and logical units (LUNs) 1, 2, . . . N. Also included in the storage device 310 are non-volatile memories 318 such as disc drives, tape drives and/or flash memory. To remind the reader of the logical nature of a LUN, a simplistic mapping between the LUNs 320, 322 and 324 and to physical memory devices 318 has been illustrated in FIG. 3. For the purposes of this discussion, a LUN will be considered interchangeable with a device 210 or 218.

Each logical unit LUN-i can be accessed through the N ports of the storage device 310. An application running on the host (device consumer) 304 can get out to the bus 302 via each of the M host bus adapters (HBAs) 308. Hence, there can be M×N paths from the host 304 to the logical device LUN-i. Again, each path can be presented as a device stack. And each stack can be associated with a devnode data structure within a device tree according to WDM architecture.

In the environment of a storage area network 300, a storage manager application operates to prevent consumer applications running on device consumers 304 from accessing LUNs to which the host (or device consumer) 304 has not been granted access by the storage manager. Such a storage manager application can be loaded onto and executed by, e.g., the host 305.

There can be instances in which a user of the storage manager wishes to delete access permission of a host to a LUN. As briefly mentioned in the Background section, this necessitates disassembling the corresponding stack, e.g., 128, by removing each of the device objects (DOs) 126, 124, 122 and 120. Removal of the PDO 120 at the root of this stack 128 requires physical disconnection of the device 102. When that occurs and the PDO 120 is subsequently removed, the corresponding data structure in the device tree, namely the device node (devnode) has its state changed to indicate that the device 102 is no longer attached to the bus.

But if the device 102 is not physically removed, then the PDO 120 cannot be removed. And if the PDO 120 is not removed, then the state of the DEVNODE is left unchanged, such that the DEVNODE continues to indicate that the device 102 exists or is in a state of limbo awaiting physical disconnection. An embodiment of the invention is a recognition that, should the user of the storage manager subsequently grant access permission again to the host, e.g., 105, the corresponding stack 128 for the device 102 cannot be rebuilt because the associated DEVNODE according to the Background Art cannot be changed from a state in which the device 102 is considered to be awaiting imminent disconnection. In other words, the DEVNODE gets stuck in a dead end state.

An embodiment of the invention solves this problem by rebooting the host whose DEVNODE for the device 102 is stuck in the dead end state due to the associated PDO 120 having not been deleted (again because the device 102 was not physically disconnected and then reconnected to the bus 104). Such a reboot permits the stack 128 to be rebuilt without the need to physically disconnect and reconnect the device 102. Unfortunately, such a solution requires the rebooting of the host.

Another embodiment of the invention solves the problem differently via the recognition of two circumstances: (1) that deletion of the PDO changes a state of the associated DEVNODE so that the stack 128 of the device 102 can be rebuilt later if need be; and (2) it is not necessary for a PDO to be the DO created by the bus driver.

Further according to the recognition embodiments of the invention, it has been recognized that a PDO is a DO that has a pointer to the associated DEVNODE. It is the plug-and-play (PnP) manager, e.g., 108, that manipulates a device object to include a pointer to the DEVNODE, thereby establishing the DO as a physical DO (PDO). The DOs that are manipulated in this manner by the PnP manager 108 are identified by the set of pointers enumerated by the bus driver 112 in reply to a connected devices query by the PnP manager 108. Hence, an embodiment of the invention is a recognition that a FiDO can be substituted (via a bus upper filter driver) for the DO generated by the bus driver 112 in the set of pointers being enumerated to the PnP manager 108, which causes the PnP manager 108 to treat the substituted DO effectively as the PDO. In other words, the DO generated by the bus driver 112 can be supplanted as the PDO via the operation of a bus upper filter driver, creating an effective PDO.

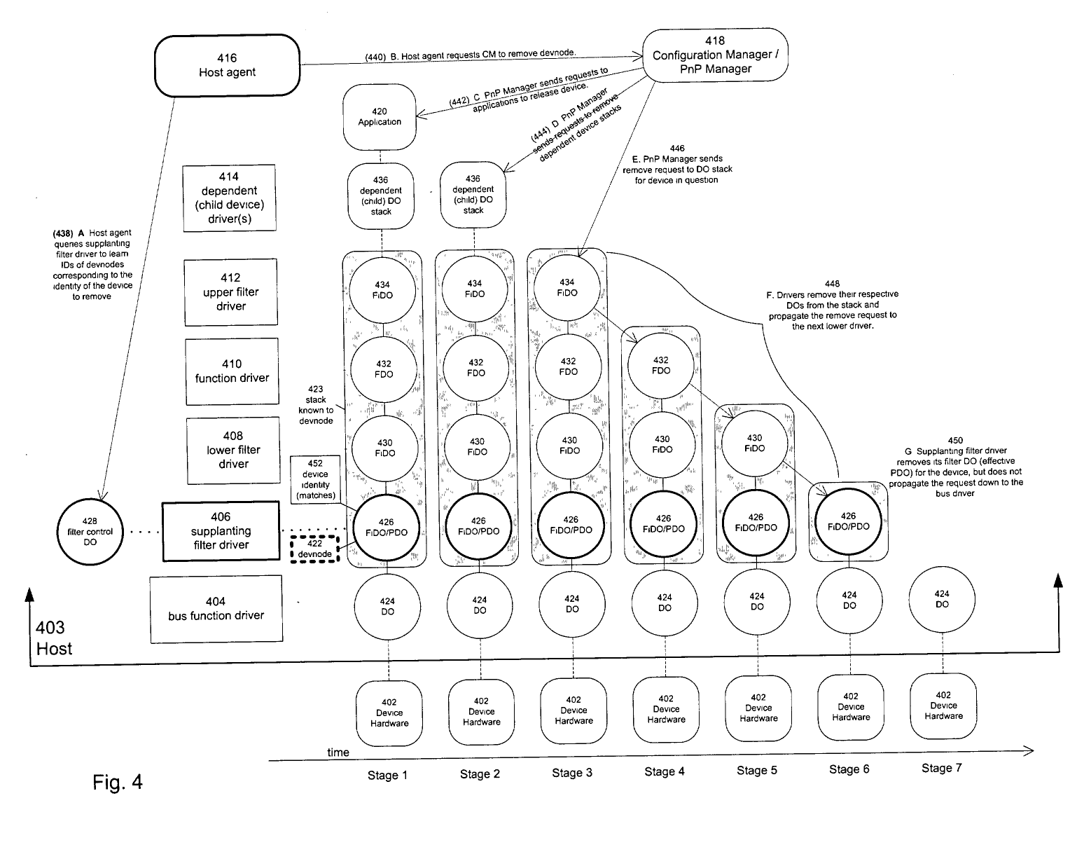

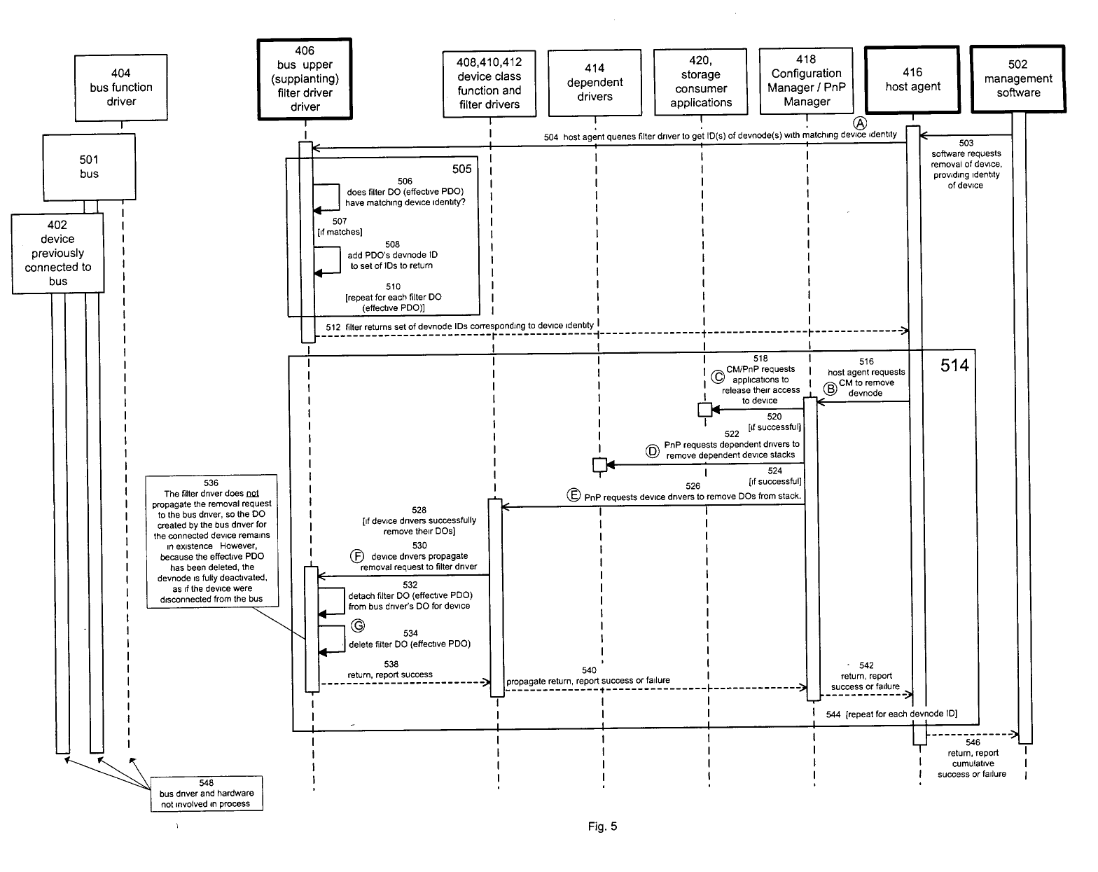

FIG. 4 is a software block diagram according to an embodiment of the invention. FIG. 4 depicts a bus function driver (bus driver) 404, a lower filter driver 408, a function driver 410, an upper filter driver 412, dependent device driver(s) 414, a host agent 416, an application 420, and a combined configuration manager (CM)/PnP manger 418 as software loaded on a host 403. A device 402, connected to a bus (501) (not depicted in FIG. 4 but see FIG. 5), is also depicted in FIG. 4. In addition, a supplanting filter driver 406 is depicted in FIG. 4.

The application 420 is the consumer of the services made available by the device 402. Such consumption by the application 420 makes the host 403 an example of a device consumer 304. The various drivers 404-412 in FIG. 4 create DOs 424-434, and in doing so a stack 423 representing a device 402. The stack 423 is associated with the devnode 422.

The stack 423 includes a filter device object (FiDO) which has a pointer to the DEVNODE 422 which, in effect, makes it the PDO (hereafter FiDO/PDO) for the device 402. Above the FiDO/PDO 426 in the stack 423 are a FiDO 430, a function device object 432 and a FiDO 434. Between the FiDO/PDO 426 and the device 402 is a DO 424, which has been created by the bus function driver 404. The various DOs are created as follows: DO 424 by the bus function driver; FiDO/PDO 426 by the supplanting filter driver 406; FiDO 430 by the lower filter driver 408; FDO 432 by the function driver 410; and FiDO 434 by the upper filter driver 412. Excepting for DO 424 (the first) each attaches its DO to the one created before it, forming this stack 423.

As well as the FiDO/PDO 426, the supplanting filter driver 406 creates a filter control DO. The host agent 416 communicates with the supplanting filter driver 406 via the filter control DO 428.

In the WDM architecture, the configuration manager and PnP manager are separate parts of the operating system that are tightly coupled. As a practical matter, they are so tightly coupled that they can be considered as being a combined part 418 for the purposes of this explanation.

How the supplanting filter driver 406 creates the FiDO/PDO 426 is disclosed in a copending and commonly assigned patent application, Attorney Docket No. 200206847-1, the entirety of which is hereby incorporated by reference.

Again, the stack 423 has a DO 424 located below the FiDO/PDO 426. Before the stack 423 is disassembled, all of the dependent DOs 436 will be deleted. Then the DOs 434-426 are successively deleted. When the last DO, namely FiDO/PDO 426 is deleted and the disassembly is complete, then the state of the DEVNODE will be changed. After the disassembly, the DO 424 will remain because no attempt has been made to delete and because the device 402 remains physically connected.

In FIG. 4, successive stages in the disassembly of the stack 423 are depicted as stages 1-7, with the sense that the progression of time moves from left to right in FIG. 4.

The sequence of exchanged messages that takes place during the disassembly of the stack 423 according to an embodiment of the invention will be explained in conjunction with the sequence diagram of FIG. 5. To aid in the reader's appreciation of the correspondence between FIGS. 4 and 5, 7 points of correspondence have been similarly labeled on each of FIGS. 4-5 as reference letters A-G, respectively.

At message 503 of FIG. 5, storage manager software 502 (corresponding to 306) acts upon an instruction from a user to delete the access permission of the host 403 to the device 402 by sending a corresponding request to host agent 416. The message 503 includes the identity of the device 402.

An example of a device identity is a resource unique identifier (RUID). A RUID provides a substantially unique ID that is independent of the host, bus and device/LUN mapping. Again, there can be multiple paths between the host 403 and a LUN, e.g., device 402. Because a RUID of a LUN is substantially unique, the multiple physical paths pertaining to the device 402 should yield the same RUID.

Then message 504 is generated by the host agent 416 and sent to the bus upper (supplanting) filter driver 406. The message 504 in FIG. 5 has also been given the reference letter, A, which corresponds to item number 438 in FIG. 4.

Via message 504, the host agent 416 queries the supplanting filter driver 406 to get the IDs of devnodes corresponding to stacks for paths that exist between the device 402 and the host 403. It is to be recalled that a total of M×N possible paths can exist between the device 402 and the host 403.

Each path to the device 402 is represented as a corresponding stack included within a DEVNODE. And the FiDO/PDO 426 in each stack has determined and stores the identity (RUID) of the device, e.g., 402, to which it relates.

The message 504 causes the supplanting filter driver 406 to enter a loop 505 in which the supplanting filter driver 406 examines the FiDO/PDOs 426 it has created. For a given FiDO/PDO 426, the supplanting filter driver 406 calls a subroutine 506 in which the RUID stored in the device extension of FiDO/PDO 426 is compared against the device identity conveyed by message 504.

If a match is found (legend 507), then the supplanting filter driver 406 adds the ID of the corresponding DEVNODE for the FiDO/PDO 426 to a set of IDs that it will return in response to the message 504. At legend 510, the supplanting filter driver repeats the loop 505 for each FiDO/PDO 426 that has been generated in the host 403.

After the loop 505 finishes, the supplanting filter driver 406 sends response 512 back to the host agent 416, the response including a set of DEVNODE IDs corresponding to the device identity conveyed by message 504. After receiving the set of DEVNODE IDs via the message 512, the host agent 416 enters the loop 514. In the loop 514, the host agent 416 directs the configuration manager to systematically disassemble each stack for which a DEVNODE ID was revealed via the response 512. This disassembly has an advantage that it can be conducted without the loss or corruption of data stored on, or intended by a consumer to be sent to, a device.

At message 516, the host agent 416 requests the configuration manager (CM)/PnP 418 to remove/disassemble a given one of the devnodes, e.g., 422, identified via the message 512. This is denoted by reference letter, B, which corresponds to item number 440 in FIG. 4. At message 518, the CM/PnP 418 requests each of the application(s) 420 to release access of the device 402 (such access being done via a handle to the stack 423). This is indicated by reference letter, C, which corresponds to item number 442 of FIG. 4.

If the application(s) 420 successfully release(s) the device 402 (legend 520 in FIG. 5), then the CM/PnP manager sends, e.g., in the form of an IRP, message 522 to the dependent device drivers 414. By waiting for a successful result (legend 520), the CM/PnP manager 418 gives the application(s) 420 an opportunity to, e.g., close files that are being accessed so as to avoid data loss or data corruption. The successful release by the application(s) 420 is denoted in stage 2 of FIG. 4 by the absence of the application 420 above the stack 423 that, in contrast, is present in stage 1.

Message 522 instructs the dependent device drivers 414 to remove/disassemble the dependent device stacks 436. Message 522 is given reference letter, D, which corresponds to item number 444 in FIG. 4. The successful disassembly of the dependent stack 436 is denoted in stage 3 by the absence of the dependent stack 436 that, in contrast, is present in stage 2. It is noted that applications or dependent drivers may not release their access to a stack, in which case the deconstruction fails. The stack 423 remains intact to avoid loss of data.

If the disassembly of the dependent stack(s) 436 is successful (see legend 524 in FIG. 5) then message 526 is sent, e.g., by sending an IRP, from the CM/PnP manager 418 to the function and filter drivers 410, 408 and 412 to remove their respective DO from the stack 423. This message is denoted by reference letter, E, which corresponds to item number 446 in FIG. 4. Successful removal of the FiDO 434, the FDO 432 and the FiDO 430 (see legend 528 of FIG. 5) is shown over the course of stages 4, 5 and 6 in FIG. 4.

Upon successful removal of the DOs 434, 432 and 430, message 530 is sent, e.g., by forwarding the IRP, from the lower-most of the drivers 408, 410 and 412, namely driver 408, to the supplanting filter driver 406. The message 530 has been given the reference letter, F, which corresponds to item 448 of FIG. 4.

In response to message 530, the supplanting filter driver 406 invokes subroutine 532 to detach the FiDO/PDO 426. At subroutine call 534, the supplanting filter driver 406 deletes the FiDO/PDO 426. This is denoted by the reference letter, G, which corresponds to item number 450 in FIG. 4.

As noted by legend 536 in FIG. 5, the supplanting filter driver 406 does not propagate the removal request IRP to the bus driver 404. As such, the DO 424 of the bus driver 404 does not get deleted so long as the device 402 remains connected to the bus 501; rather, DO 424 remains as a remnant DO. The deletion of the FiDO/PDO 426 causes the state of the DEVNODE 422 to be changed, making the DEVNODE 422 fully deactivated as if the device 402 had been physically disconnected from the bus 501.

Via response 538, the supplanting filter driver 406 returns a successful report indicating that the stack has been removed, by returning the request IRP upward. At message 540, the function and filter drivers 410, 408 and 412, respectively, propagate the IRP representing success (or failure if appropriate) to the CM/PnP manager 418. Via response 542, the CM/PnP manager 418 propagates the report of success or failure to the host agent 416.

Then, the loop 514 is repeated for the next DEVNODE ID revealed in the set provided via the message 512, as indicated by legend 544 in FIG. 5. After loop 514 has been completed, i.e. after all devnode IDs have been processed, message 546 is sent from the host agent 416 to the manager software 502 indicating cumulative success or failure.

In FIG. 5, no messages are exchanged with the device 402, the bus 501 and the bus driver 404. This reflects that these participants are not involved. This is consistent with the DO 424 of the bus driver 404 not being deleted in FIG. 4, i.e., remaining in stage 7 as a remnant DO.

As a result, if the user of the storage manager software 502 subsequently grants the host 403 access to the device 402, the stack 423 can be rebuilt without the need to reboot the host and/or physically disconnect and then reconnect the device 402.

The invention may be embodied in other forms without departing from its spirit and essential characteristics. The described embodiments are to be considered only non-limiting examples of the invention. The scope of the invention is to be measured by the appended claims. All changes which come within the meaning and equivalency of the claims are to be embraced within their scope.

What is claimed is:

1. A code arrangement on a computer-readable medium for use in a system having a bus, a bus driver, a host connected to said bus and one or more devices connected to said bus,
execution of said code arrangement by one or more processors of the host causing a stack representing one of said devices to be disassembled such that rebuilding said stack does not require physical disconnection and reconnection of said device,
said stack having a plurality of device objects (DOs), a lower DO in said stack being associated with the bus driver and an upper DO in said stack located above said lower DO being recognized as the physical DO (PDO) by a data structure associated with said device in a device tree,
the code arrangement comprising:
a removal code portion to remove each DO from said stack located above said lower DO including said PDO;
said lower DO associated with said bus driver surviving as a remnant DO; and
a state change code portion to change a state of said data structure in said device tree to permit rebuilding of said stack based upon said remnant DO.

2. The computer-readable code arrangement of claim 1, wherein said rebuilding of said stack does not require rebooting of said host.

3. The computer-readable code arrangement of claim 1, wherein the removal of each DO from said stack located above said lower DO including said PDO is accomplished without data corruption or data loss experienced by a consumer of device services.

4. The computer-readable code arrangement of claim 1, wherein each of said code portions conforms to the WINDOWS Driver Model (WDM) architecture.

5. The computer-readable code arrangement of claim 1, wherein said bus is part of a storage area network and said one or more devices include at least one logical unit.

6. The computer-readable code arrangement of claim 5, wherein said host is operable to run an application program that is a consumer of said at least one logical unit.

7. A method of disassembling a stack within a host in a system,
the system having a bus, said host connected to said bus, a bus driver executed within said host, and one or more devices connected to said bus,
said stack representing a device to be disassembled such that rebuilding said stack requires neither a reboot of said host nor physical disconnection and reconnection of said device,
said stack having a plurality of device objects (DOs), a lower DO in said stack being associated with the bus driver and an upper DO in said stack located above said lower DO being recognized as the physical DO (PDO),
the method comprising:
removing each DO from said stack located above said lower DO including said PDO
said lower DO associated with said bus driver surviving as a remnant DO; and
changing a state of said data structure in said device tree to permit rebuilding of said stack based upon said remnant DO.

8. The method of claim 7, wherein said rebuilding of said stack does not require rebooting of said host.

9. The method of claim 7, wherein the removal of each DO from said stack located above said lower DO including said PDO is accomplished without data corruption or data loss experienced by a consumer of device.

10. The method of claim 7, wherein said bus is part of a storage area network.

11. A host device in a system having a bus, a bus driver and one or more devices, said host and said one or more devices being connected to said bus, the host disassembling a stack representing a device such that rebuilding said stack would require neither a reboot of said host nor physical disconnection and reconnection of said device by loading and executing a code arrangement according to claim 1.

12. The apparatus of claim 11, wherein said rebuilding of said stack does not require rebooting of said host.

13. A method,
for use with a system having a bus, a bus driver, a host connected to said bus and one or more devices connected to said bus, there being multiple paths by which said host can access a device, each path having a path identification (ID),
of mapping one of said devices to one or more paths by which said host accesses said one of said devices,
the method comprising:
receiving, as a target ID, an ID of one of said devices;
providing a set of IDs of devices (device IDs) associated with said host;
comparing device IDs in said set against said target ID, respectively;
determining, for each device ID that matches said target ID, a corresponding path ID;
forming a set of path IDs whose corresponding device ID matches said target ID;
returning said set of path IDs corresponding to said target ID.

14. The method of claim 13, wherein each of said paths is represented as a logical device stack according to the WINDOWS Driver Model (WDM), said stack having a plurality of device objects, one of which relates said path ID to the corresponding device ID.

15. The method of claim 13, wherein at least one of said devices is a logical unit representing access to at least a part of at least one physical device.

16. A code arrangement on a computer-readable medium for use with a system having a bus, a bus driver, a host connected to said bus and one or more devices connected to said bus, there being multiple paths by which said host can access a logical device, each path having a path identification (ID),
execution of said code arrangement by one or more processors of the host causing there to be a mapping of one of said devices to one or more paths by which said host accesses said one of said devices,
the code arrangement comprising:
a receiving code portion to receive, as a target ID, an ID of one of said devices;
a roster code portion to provide a set of IDs of devices (device IDs) associated with said host;
a comparison code portion to compare device IDs in said set against said target ID, respectively;
a determining code portion to determine, for each device ID that matches said target ID, a corresponding path ID;
a forming code portion to form a set of path IDs whose corresponding device ID matches said target ID;
a replying code portion to return said set of path IDs corresponding to said target ID.

17. The computer-readable code arrangement of claim 16, wherein each of said code portions conforms to the WINDOWS Driver Model (WDM) architecture.

18. The computer-readable code arrangement of claim 16, wherein each of said paths is represented as a device stack according to said WDM, said stack having a plurality of device objects, one of which relates said path ID to the corresponding device ID.

19. The computer-readable code arrangement of claim 16, wherein said bus is part of a storage area network.

20. A host device in a system having a bus, a bus driver and one or more devices connected to said bus, wherein the host is connected to said bus, there being multiple paths by which said host can access a device, each path having a path identification (ID), the host being operable to map one of said devices to one or more paths by which said host accesses said one of said devices by loading and executing a code arrangement according to claim 16.

21. An apparatus,
usable in a system having a bus, a bus driver, a host connected to said bus and one or more devices connected to said bus,
for disassembling a stack representing one of said devices such that rebuilding said stack does not require physical disconnection and reconnection of said device,
said stack having a plurality of device objects (DOs), a lower DO in said stack being associated with the bus driver and an upper DO in said stack located above said lower DO being recognized as the physical DO (PDO),
the apparatus comprising:
removal code means for removing each DO from said stack located above said lower DO including said PDO
said lower DO associated with said bus driver surviving as a remnant DO; and
state change means for changing a state of said data structure in said device tree to permit rebuilding of said stack based upon said remnant DO.

22. The apparatus of claim 23, wherein said rebuilding of said stack does not require rebooting of said host.

23. An apparatus,
usable with a system having a bus, a bus driver, a host connected to said bus and one or more devices connected to said bus, there being multiple paths by which said host can access a device, each path having a path identification (ID),
for mapping one of said devices to one or more paths by which said host accesses said one of said devices,
the apparatus comprising:
receiving means for receiving, as a target ID, an ID of one of said devices;
roster means for providing a set of IDs of devices (device IDs) associated with said host;
comparison means for comparing device IDs in said set against said target ID, respectively;
determining means for determining, for each device ID that matches said target ID, a corresponding path ID;
forming means for forming a set of path IDs whose corresponding device ID matches said target ID;
replying means for returning said set of path IDs corresponding to said target ID.
